(19) United States
(12) Patent Application Publication
(10) Pub. No.: US 2019/0342085 A1
(43) Pub. Date: Nov. 7, 2019

(54) SYSTEM AND METHOD FOR TRACKING PRODUCT AND PROVIDING VERIFIED PRODUCT INFORMATION AND CONSUMER REWARDS

(71) Applicant: Green Light Solutions Corp., Vancouver (CA)

(72) Inventors: Nathan John Walter KUBE, Vancouver (CA); Frank Joseph MARCUS, Vancouver (CA); Samuel Alexis WEBB, Richmond (CA); Toby Sharrim Theun SUMMERS, Victoria (CA)

(21) Appl. No.: 16/401,823

(22) Filed: May 2, 2019

Related U.S. Application Data
(60) Provisional application No. 62/665,755, filed on May 2, 2018.

(51) Int. Cl. H04L 9/08; G06K 7/12; G06Q 10/08

(52) U.S. Cl. CPC H04L 9/0825; G06Q 10/0833; G06Q 10/087; G06K 7/12

(57) ABSTRACT

A blockchain or other cryptographic ledger platform with a keypair-based identity for issuance of tokens using machine readable indicia embedded within product packages and/or encoded external to the product packages. The platform generates blocks for a blockchain or other cryptographic ledger to record data relating to the product supply chain and token issuance and redemption.

### CROSS-REFERENCE TO RELATED APPLICATION

This application claims the benefit of priority of U.S. Provisional Patent Application No. 62/665,755, which was filed on May 2, 2018 and is hereby incorporated herein by reference in its entirety.

### FIELD

The present disclosure generally relates to the field of supply chain management of controlled products across multiple regulatory jurisdictions, blockchain and cryptographic distributed ledgers.

### INTRODUCTION

Embodiments described herein relate to blockchain and cryptographic ledgers. For example, agriculture producers may want to provide verification of data that describes the nature of the product including its genetic profile, chemical composition, environmental conditions during growth, and so on. Organizations may want to collect track consumer and product data, such as identity management data and supply chain tracking data, for improved analytics, reports and compliance.

### SUMMARY

In accordance with an aspect, there is provided a process for creating a keypair-based identity management application comprising: generating a keypair-based identity; calculating a keypair-based identity public address for the keypair-based identity using a keypair-based identity private key at a secure key storage; transmitting the keypair-based identity public address to an application programming interface to generate a signed keypair-based identity address; registering the keypair-based identity at a cryptographic ledger; storing the signed keypair-based identity address at a producer storage; and generating and depositing tokens to the signed keypair-based identity address using the cryptographic ledger. The process may further comprise transmitting attestation data along with the keypair-based identity public address to generate the signed keypair-based identity address. The keypair-based identity may be a producer keypair-based identity generated for a producer of a product, and wherein generating and depositing tokens comprises generating and depositing tokens to a signed producer keypair-based identity address in response to the producer registering product information about the product. The process may further comprise generating a package keypair-based identity generated for a package of the product from the producer, and providing a package private key within the package. The process may further comprise generating a consumer keypair-based identity generated for a consumer purchasing the package, and generating and depositing tokens to a signed consumer keypair-based identity address in response to the consumer redeeming the package private key.

In accordance with an aspect, there is provided a system for tracking product. The system comprises: a cryptographic ledger service configured to generate a plurality of keypair-based identity, each keypair-based identity comprising a keypair identity address, a public key and a private key; a producer interface and a consumer interface, both in communication with the cryptographic ledger service. The producer interface is configured to: receive a registration request and product information for a package of product from the producer; and, provide the producer with a package keypair-based identity comprising a package public key for placement on an exterior of the package and a package private key for placement in an interior of the package such that the package private key is only accessible after opening the package. The consumer interface is configured to provide a consumer with a consumer keypair-based identity comprising a consumer keypair identity address, a consumer public key and a consumer private key; receive a redemption request from the consumer, the redemption request comprising the package private key and the consumer public key; validate the package and determine a package reward token for the package based on the package private key; and, transfer the package reward token to the consumer keypair-based identity. The redemption request may further comprise attestation data verifying that the consumer is a valid purchaser of the package. The system may further comprise an analytics platform configured to collect data based on user behaviour. The producer interface may be configured to transfer a registration reward token to a producer keypair-based identity in response to receiving the registration request.

In accordance with an aspect, there is provided a process for tracking products and providing consumer rewards comprising: receiving a product registration request and product information for a package containing product from a producer; providing the producer with a package keypair-based identity comprising a package public key for placement on an exterior of the package and a package private key for placement in an interior of the package such that the package private key is only accessible after opening the package; providing a consumer with a consumer keypair-based identity comprising a consumer keypair identity address, a consumer public key and a consumer private key; receiving a redemption request from the consumer, the redemption request comprising the package private key and the consumer public key; validating the package and determining a package reward token for the package based on the package private key; and, transferring the package reward token to the consumer keypair identity address. The process may comprise printing a machine-readable indicia containing the package public key on the exterior of the package. The process may comprise printing a machine-readable indicia containing the package private key on an interior surface of the package. The process may comprise printing a machine-readable indicia containing the package private key on an item for placement in the interior of the package. The machine-readable indicia may be printed using ink visible only in ultraviolet (UV) or near-UV light. The process may comprise receiving attestation data from a retailer of the package confirming that the consumer is a valid purchaser of the package.

In accordance with an aspect, there is provided a blockchain or other cryptographic ledger platform with a keypair-based identity application for issuance of tokens using machine readable indicia embedded within product packages or encoded externally on product packages with features described herein.

In accordance with an aspect, there is provided a blockchain or other cryptographic ledger platform with a keypair-based identity application for issuance of tokens using machine readable indicia, the platform comprising a processor configured to generate blocks or data for a blockchain or other cryptographic ledger to record data relating to the product supply chain and token issuance and redemption.

In accordance with an aspect, there is provided a blockchain or other cryptographic ledger platform to implement an identity or wallet creation process.

In accordance with an aspect, there is provided a blockchain or other cryptographic ledger platform to implement a lot registration process.

In accordance with an aspect, there is provided a blockchain or other cryptographic ledger platform to implement a package registration process.

In accordance with an aspect, there is provided a blockchain or other cryptographic ledger platform to implement a package redemption process.

In accordance with an aspect, there is provided a blockchain or other cryptographic ledger platform to implement a reward redemption process.

In various further aspects, the disclosure provides corresponding systems and devices, and logic structures such as machine-executable coded instruction sets for implementing such systems, devices, and methods.

In this respect, before explaining at least one embodiment in detail, it is to be understood that the embodiments are not limited in application to the details of construction and to the arrangements of the components set forth in the following description or illustrated in the drawings. Also, it is to be understood that the phraseology and terminology employed herein are for the purpose of description and should not be regarded as limiting.

Many further features and combinations thereof concerning embodiments described herein will appear to those skilled in the art following a reading of the instant disclosure.

### DESCRIPTION OF THE FIGURES

FIG. 1 shows an overview of a blockchain token or other cryptographic ledger platform according to some embodiments.

FIG. 2 is a flowchart diagram of a process for producer keypair-based identity creation according to some embodiments.

FIG. 3 is a flowchart diagram of a process for lot registration according to some embodiments.

FIG. 4 is a process for consumer keypair-based identity creation according to some embodiments.

FIG. 5 is a process for package redemption according to some embodiments.

FIG. 6 is a process for reward redemption according to some embodiments.

FIG. 7 is a schematic diagram of a blockchain or other cryptographic ledger platform for tokens according to some embodiments.

FIG. 8 is a flowchart diagram of a process for verification according to some embodiments.

### DETAILED DESCRIPTION

Embodiments of methods, systems, and apparatus are described through reference to the drawings.

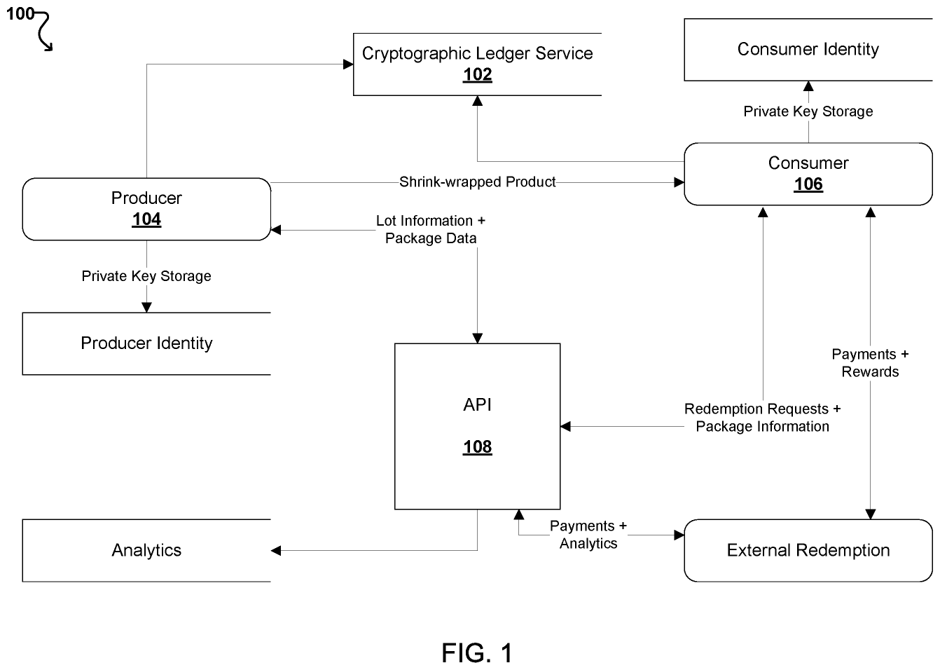

FIG. 1 shows an overview of a cryptographic ledger management platform 100 according to some embodiments. As described in detail below, the cryptographic ledger management platform 100 includes a cryptographic ledger service 102 that is used to generate keypair-based identities (such as, for example, crypto-wallet applications) for a variety of entities and items, including producers, consumers, retailers, compliance inspectors, lots of product and/or packages of product (e.g. commodities such as agricultural products). Each keypair-based identity has a private key, a public key, and a keypair address calculated based on the public key. The ledger service 102 may, for example, comprise any suitable implementation of a distribute ledger service, hyperledger service, blockchain service, x.509 service, or other service.

The cryptographic ledger management platform 100 can enable a cryptographically secured electronic keypair-based identity, or computer application to manage and store value and information properties (meta-data) of a commodity or other product to be represented by a crypto-token (also referred to simply as a “token”). An example commodity is an agriculture product that can be packaged by a producer 104 in a retail package with a seal. The crypto-token can store information about the commodity in machine-readable format and may only accessible to the electronic wallet after the retail packaging seal is broken. The crypto-token can be used for identity management, supply chain tracking, and store data concerning the physical, chemical, psychoactive and other properties of the product. The crypto-token has a class of data, that can be referred to as “private” data, that is only accessible once the package seal is broken by a consumer 106. There can be authentication processes enforced at the point of retail sale (e.g. identification verification) to ensure that only the authorized consumer is able to access this information.

A producer 104 initiates the tracking of the commodity or product packaged for sale, either retail or wholesale, by submitting a registration request through a producer interface. Producer and lot information is printed on packages, in some embodiments in a machine-readable format such as a barcode, QR code, or other device. The lot and/or package details are posted to the management platform 100 through an API 108 and recorded in a database. A universal identifier and a hash of the lot details can be recorded as blocks of a blockchain or entries in a distributed cryptographic ledger in some embodiments. The producer 104 may want to provide attestation that the product was produced by them for supply chain authentication. The producer 104 may want to provide detailed information about the product, including its brand name, a lot number, chemical composition, genetic information, photos, and/or other attributes (e.g. the staff involved in its production) that is accessible to the consumer 106. The producer 104 may also want to gather consumption information regarding the product.

The producer 104 can do this by providing a serial number for each package and creating a keypair-based identity for each package. The producer 104 can record a public information block on a public cryptographic ledger or Seed to Sale system using a ledger service 102. The producers 104 can be rewarded with tokens for registering product packages. The management platform 100 can minimize the producer keypair-based identity functionality by implementing wallet or producer operations in some embodiments. The producer 104 includes a computing device that is configured to interact with cryptographic ledger service 102 to create new blocks, write to blocks and read blocks on a blockchain. The producer 104 can create an entry for the product on the cryptographic ledger using ledger service 102.

The public information block can contain: (i) Lot number; (ii) Data Reference Record; (iii) Verification hash/signature; (iii) Producer public key signed by the management platform 100.

The Data Reference Record can be generated using a base path combined with UUID or CRC32+salt. The Data Reference Record can be stored by the producer 104 on a server they control in some example embodiments. The verification hash/signature can be generating using a lot identifier combined with a data uniform resource locator. The producer 104 can sign the URL with the producer keypair identity private key in some embodiments.

In some embodiments, a universal identifier (e.g. UUID) and a hash of lot or product data can be recorded as blocks in a block chain, entries in a cryptographic ledger, or in a database (e.g. of management platform 100). For example, cryptographic ledger token platform 100 can create a standard database table, with two or three columns, in an example embodiment. The key(ed) column can be in the format of a UUID, and the data column which can be either text blob or even binary blob. A third column can store a shasum (e.g. SHA512) of the second column's contents, for easier comparison. An example workflow can be: Create new random/semi-random UUID to serve as database key, then insert it into a new row; Insert your text or binary data into the new row referenced in previous step; Compute a shasum (e.g. SHA512) of the data from previous step; Cryptographically sign the concatenated values (from previous steps) with a private key; Compute a checksum (e.g. CRC32) of the UUID and the shasum from the previous steps to ensure data recoverability (as opposed to cryptographic integrity); The overall data produced can be stored in a public cryptographic ledger service 102. This process can enable the integrity of private database records to be guaranteed by public cryptographic ledger records while simultaneously preserving data privacy.

The outside of the package for the product can have a public QR code or other machine-readable indicia that contains a transaction ID of the package (linked to the cryptographic ledger service 102) and a package keypair address. In some embodiments a licensed producer ID and lot number may be extracted from a GS1 barcode.

The data URL can direct a user device to a web page or database record hosted by management platform 100 as a centralized database. For the example product of an agriculture product, the web page can display the following example information: lot size in grams; company name and logo; plant or stock name and logo; chemical ratios; genetic information including terpene data; lab testing results for pesticide, microbial contaminants, mold count; photographs of the product; and so on.

Producers 104 can register their package via a producer interface of the management platform 100. The management platform might not be accountable or liable for the completeness of the record. A standard might be recommended that the management platform API 108 can parse and render.

In some embodiments, every package with product from a given lot can reference the same public information to provide consistency.

There can be different processes for the verification of information used by the system. There may be verification of the consumer or retail purchaser by a compliance inspector or an authorized agent of the appropriate regulatory jurisdiction, for example.

For user verification (being either the retail product consumer or the compliance inspector), this can be done: before the package is purchased (and before the package seal is breached, providing access to the internal QR code or other machine-readable indicia to scan), retrieve product information based on the data available on the package (or encoded in a QR code or other machine-readable indicia on the front of the package). This can be scanned any number of times by any number of applications.

There can be verification of information about the product including the source of origin, contaminant testing, genetic testing, chemical composition, supply chain integrity and environmental production data is queried using information available on the outside of the package such as the brand, product name, lot number and serial number, which may be encoded as a QR code or other machine-readable indicia to simplify data entry but not necessarily, manual input also suffices. The consumer's application (presumably on a mobile device) adds additional information such as the application unique identifier and if permitted, the GPS coordinates at the time of query and historical information captured in the application.

Once the query is received by the management platform API 108, the platform 100 records the application identifier and query data in the database to record that a given package was queried and it verifies the integrity of the information through correlation with lot and/or package registration and historical information previously captured during the registration process. Additional analytics are produced to indicate the probability that the given package is derived from a legitimate lot of product. Once the query has been processed and verification is completed, the results are returned to the consumer's application for viewing.

Compliance inspectors can at any point in the supply chain use the same basic functionality but receive additional information generated from the analysis to provide indication when there is suspicion that a given package may not be legitimate, for example when a lot appears to have more retail packaged product volume that would be possible (e.g. the lot was 1 kg and 1200 g of packaged product has been detected through product information and/or reward redemption scans).

In some embodiments, the package can include a physical item with a QR code or other machine-readable indicia that can contain the package private key. The package can also be encoded with another machine-readable indicia containing the package public key that can be scanned or read by a machine without opening the seal of the package, in some embodiments. The package private key might not be stored with the management platform 100 for additional security in some embodiments. The package private key can be created when the producer registers the package, and then can be printed and inserted into the package for distribution to the consumer 106. In some embodiments, the machine-readable indicia may be encoded using invisible ink and it may also contain tracking information on each package. The encoding may be done using a UV-only ink, so that a specialized sensor/UV-light source is required in order to read the printed indicia; without said equipment, the packaging looks plain to the naked eye. The machine-readable indicia can be multi-spectral, implying for example the indicia can be printed using ink visible only in near-UV.

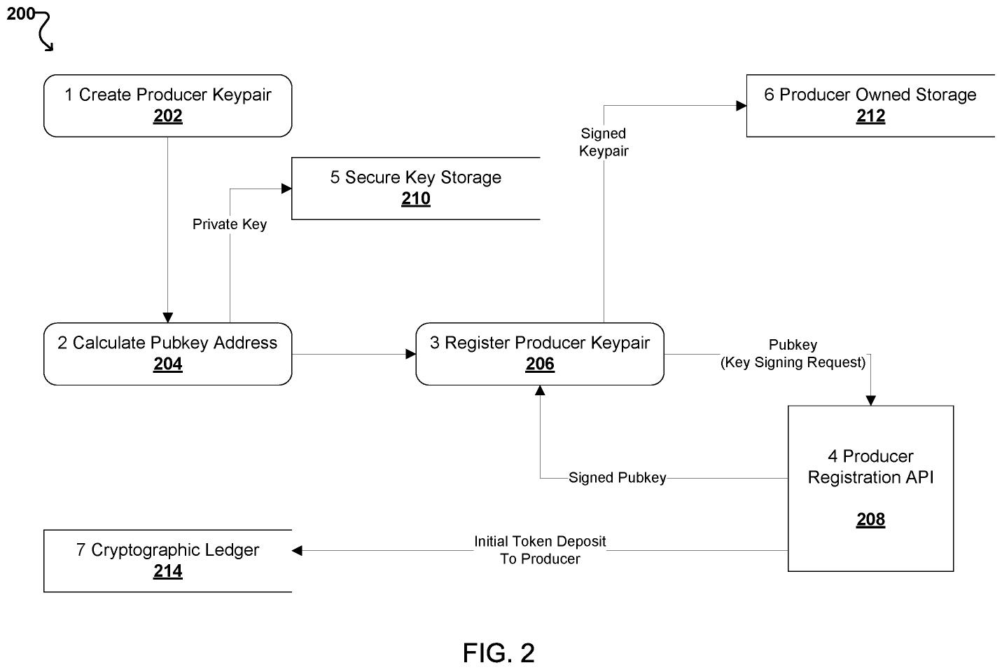

FIG. 2 is a flowchart diagram of a process 200 for producer keypair-based identity creation according to some embodiments.

At 202, a processor creates a producer keypair-based identity. For example, on a computer local to the producer, the processor can generate a random producer private key using a software utility that can be referred to as “keypair identity management software”. This process can be specific to the blockchain or cryptographic ledger service 102 with respect to ciphers and formatting (e.g. ERC-20) for token specification.

At 204, a processor calculates the producer public keypair identity address. The producer public keypair identity address can be derived from the producer public key using standard cryptographic functions.

At 210, the processor stores the producer private key at a data storage device. For the security of the producer's 104 keypair-based identity, at 212, the private key can be stored on a medium that the producer 104 controls. For example, a separate device (e.g. a hardware wallet) can be used instead of saving the producer private key to disk. In some embodiments, no entity other than the producer can access the producer private key.

At 206, management platform 100 registers the producer keypair-based identity. The management platform 100 keypair-based identity software can construct a “Key Signing Request” (KSR) that includes the producer keypair identity public address, the producer's 104 registered name, address and contact information. The KSR can be submitted to management platform 100 using an API call. The KSR enters a “pending” state while the registration request is reviewed by management platform 100. The registration request is verified through automated analysis of publicly available information. If registration is granted, the “Key Signing Response” will be produced that can be retrieved by the client. Similar to the creation of an x.509 Certificate, notification of successful registration can be completed out-of-band (e.g. via email or another means) and the keypair identity software will use an API to check the status and retrieve the signed KSR.

At 208, the management platform 100 Producer Registration API provides a set of API functions to a processor to register with the management platform 100 private backend.

At 212, the processor stores the signed producer keypair-based identity at a Producer-Owned Storage. The keypair identity management software can use this data to perform Management platform API calls. This may not be security-sensitive and can be stored on the computing device running the keypair identity management software.

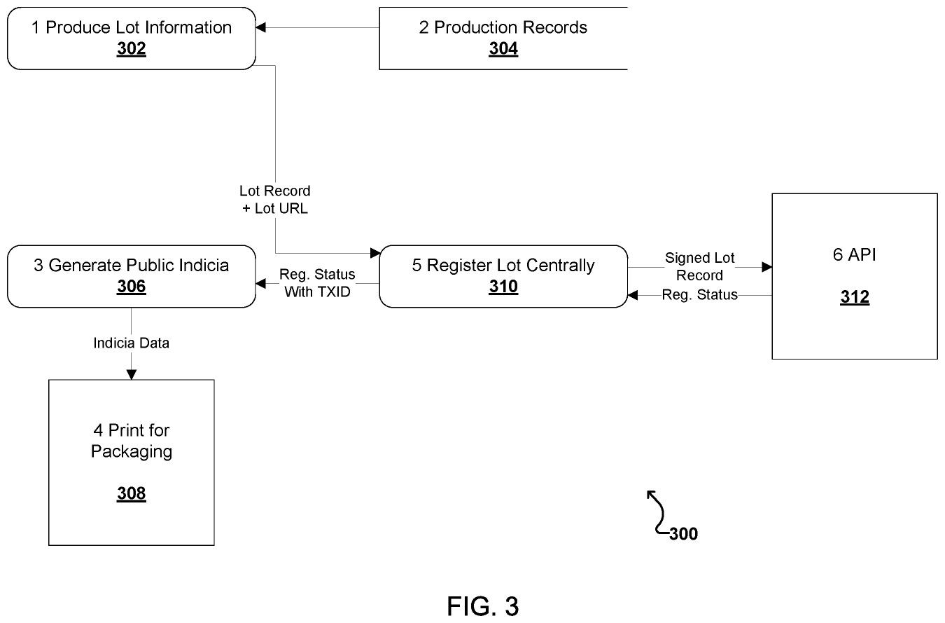

FIG. 3 is a flowchart diagram of a process 300 for lot registration according to some embodiments. A similar process may be used for package registration as described below.

At 302, a processor retrieves lot information from production records and compiles the data record for the lot. Referring back to the agriculture product example, the data record can include information such as the assigned lot number, brand name, strain name, chemical analysis, genetic analysis, lot volume (grams), photographs, staff involved in production (grower, trimmer, packager).

At 304, the processor stores the production records at a data storage device with a database containing the data required to produce the lot registration record. This can be configured to provide different functionality such as a “Seed to Sale” platform, GMP management tools, written records, information written to public blockchain or another cryptographic ledger system. The processor can correlate multiple data sources. For example, management platform 100 can aggregate the data and provide “at the time of creation” attestation of existence and validity.

At 306, a processor can generate the Public QR Code or other machine-readable indicia. For example, this can be a QR code or other indicia produced with a reference to the management platform 100 transaction identifier of the lot registration record.

At 308, the processor can send a call to the API to trigger printing of the QR code or other machine readable indicia for packaging. A variety of methods can be used to append the data to the outside of packaging, and can vary according to what packaging regulations will permit. For example, the indicia can be printed to a sticker to place on the outside of the package, but the indicia could also be printed directly on the packaging at the time of order. The public QR code or other machine-readable indicia can be stable for the lot, in order to print the lot number on the package.

At 310, the processor can register the lot with management platform 100. This may be accomplished by writing to a public blockchain or cryptographic ledger (e.g. blockchain service 102), a private blockchain or cryptographic ledger, or to a private traditional database.

At 312, the processor calls the management platform API 108 which provides functions for registering the lot. In some embodiments, all registration requests must be signed by the producer private key.

The processor can also implement a process for package registration, which may be similar to the process 300 of FIG. 3. As each package is populated with product, a serial number is assigned by a Seed to Sale platform that can include the processor. A package keypair-based identity can be generated by the packager. The package private key is written to a QR code or other machine-readable indicia and inserted into the package. A Package Registration Request is sent to the management platform API 108 containing the package serial number, product lot number, package public key and signed by the package private key. A database entry is created using a package signature. The package signature may, for example, be generated by cryptographically hashing the package data provided by the producer using the package private key.

The processor can also implement a consumer interface according to some embodiments.

The consumer purchases product packages after properly attesting their identity to the retailer. A QR code or other machine-readable indicia on the outside of the package encodes a reference to the public information block saved on the blockchain or another cryptographic ledger. In some embodiments, GS1 barcode data on the package may be used to lookup the ledger transaction ID in a central database. The consumer might want to: Be able to access detailed information about the product they have purchased; Share specific information about themselves and their purchasing behaviour and preferences (for example, including previous history, comparisons of the same product from different lots, and/or subjective comments on product experiences); Control the types of recipients and what kind of data they can receive; Receive management platform tokens value as a reward for authorizing the use of the data; and Redeem the tokens for something they value.

The consumer can access some of these functions by using a consumer interface including a mobile phone application to scan a QR code or other machine readable indicia (e.g. GS1 barcode) or enter a brand and lot number to retrieve the public information block for the product. The mobile phone application can use the public information block to retrieve the Data URL. The application can verify the content of the Data URL by calculating its hash and comparing it to the stored hash in the public information block.

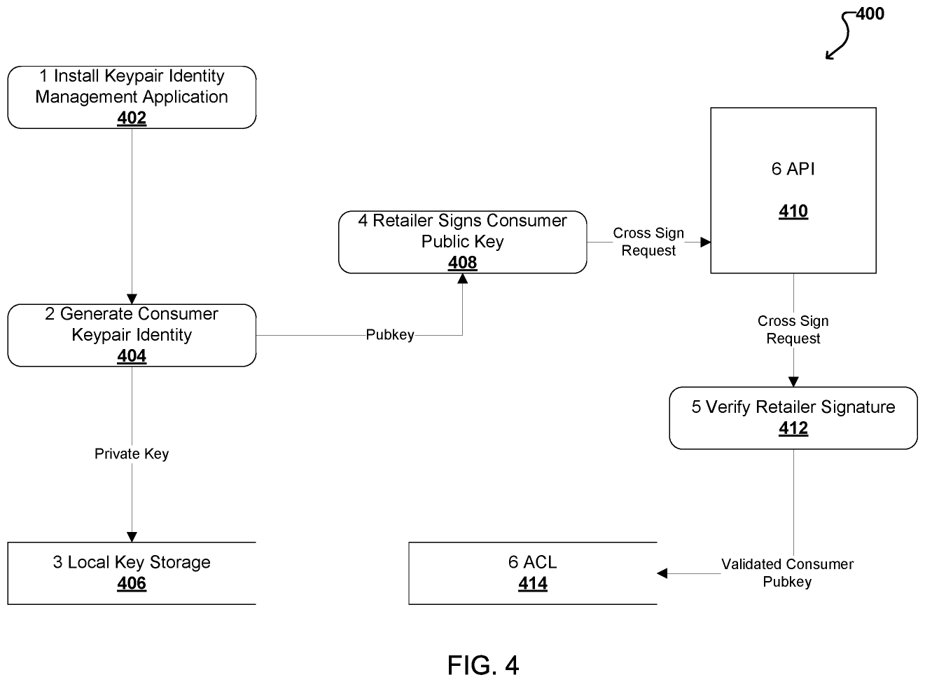

FIG. 4 is a process 400 for consumer keypair-based identity creation according to some embodiments.

At 402, a processor initiates the install of a keypair-based identity application on the consumer device. The management platform generates a UUID on installation that is included in all management platform API 108 calls to create an anonymous association between a specific user and the data they provide to management platform 100 in order to track history.

At 404, the processor generates a consumer keypair-based identity. The consumer keypair-based identity can be created by selecting a random consumer private key. The consumer public key can be generated therefrom, and the consumer keypair identity address is generated from the public key. However, the consumer keypair-based identity cannot be used to receive management platform tokens until it has been granted permission in the management platform Access Control List (ACL).

At 406, a processor generates a local key store. The consumer private key is stored on the consumer's device or on a secure hardware keypair storage device in some embodiments.

At 408, a retailer signs the consumer public key. In some embodiments, the Management platform 100 keypair-based identity creation may only be registered by attested consumers. To ensure this is the case, when the consumer keypair-based identity is created the consumer public key is signed by the retailer and submitted to the management platform API 108 at 410. In some embodiments the retailer may have its own keypair-based identity generated by the processor, and may sign the consumer public key with the retailer private key.

At 412, the processor can verify a Retailer Signature. For example, the Management platform 100 verifies the retailer signature.

At 414, the processor adds the validated consumer public key to the Management platform address Access Control List (ACL). The processor can also implement privacy and access control to consumer's data.

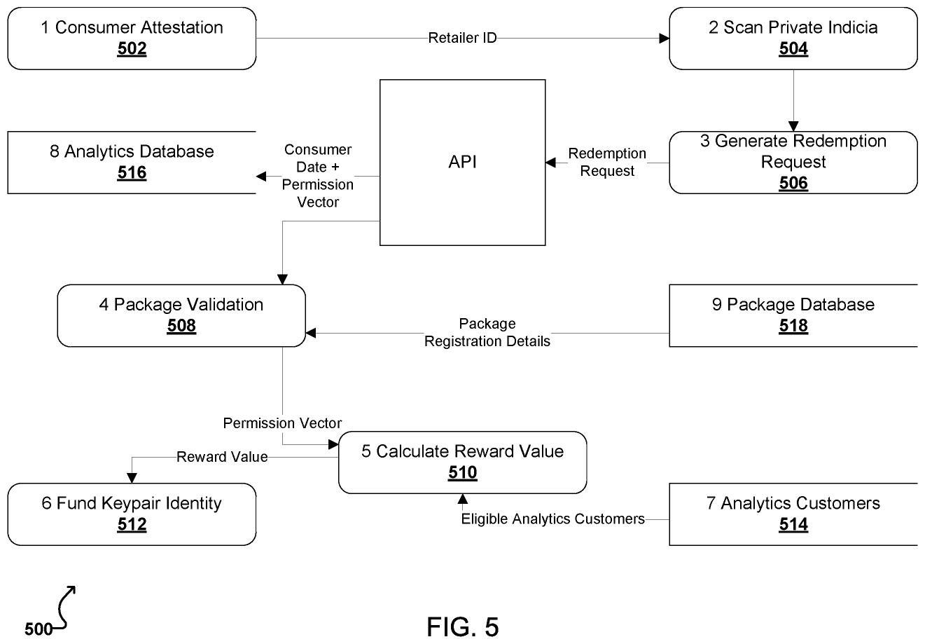

FIG. 5 is a process 500 for package redemption according to some embodiments.

At 502, the processor implements consumer attestation. This is an event that ensures that the consumer has the legal right to possess a controlled product. A retailer device can submit this attestation data to the processor. This can be assured either with a package insert that cannot be accessed until the package seal is breached, or at the point of purchase with co-operation of the retailer. In some embodiments, a Retailer ID is provided to each retailer to track which retailer is selling the product that can be submitted with the attestation data.

At 504, the keypair-based identity application installed on the consumer device can scan a private QR code or other machine-readable indicia (after the package has been opened). The private indicia contains the package private key, proving physical control of the package.

At 506, the management platform identity application can generate a Redemption Request. The keypair-based identity application generates a Redemption Request containing the consumer keypair identity address, the package serial number, the management platform identity application ID and signed with the package private key. The request is sent to the management platform API 108.

At 508, the processor implements Package Validation. The processor uses the package private key to look up the package record in the Management platform internal database and confirm the match with the expected package serial number to establish package authenticity.

At 510, the processor calculates Reward Value. Rewards can be calculated just in time, providing an opportunity to vary the reward according to several factors including the history of the consumer, the data collected and use permissions provided by the consumer, market demand for analytics based on producer, strain, location and other properties.

At 512, the processor generates the Fund Package. The calculated reward value is transferred to the consumer keypair identity address.

At 514, a processor triggers a call to an Analytics Customer Database. The Management platform Analytics Customers are those who have been accredited by management platform 100 to purchase the data aggregated and analyzed from Management platform Consumers. Data about analytics customers can be utilized when determining the reward value at 510, for example.

At 516, the processor triggers a call to an Analytics Database. Data provided by consumers, including privacy control information, stored in the Management platform analytics database and processed through a variety of analysis. Data can be transmitted to the analytics customer using Management platform tokens, for example. Analytics customers can acquire Management platform tokens from consumers by providing rewards.

At 518, the Package Database stores the registration of packages for use in package validation.

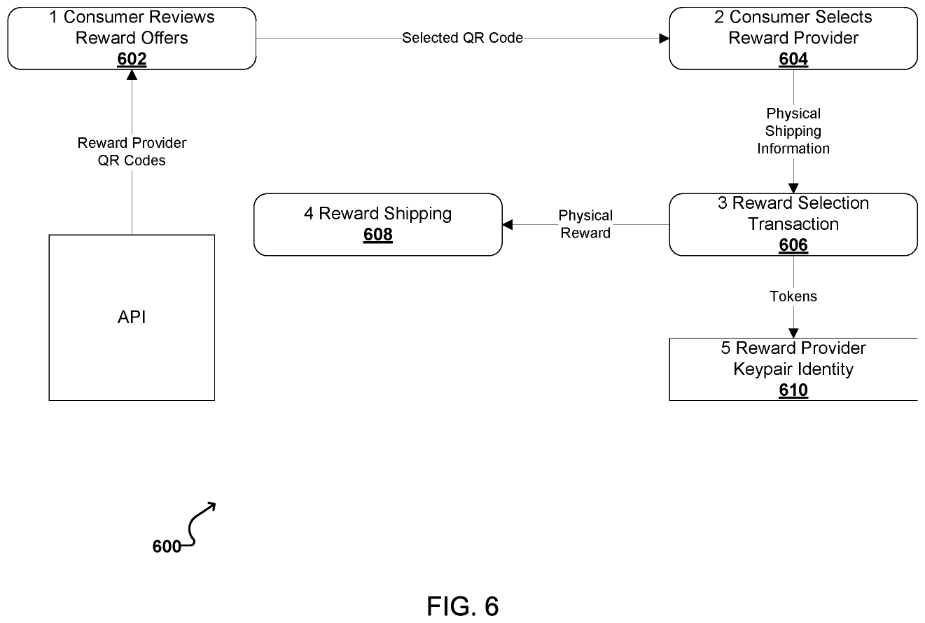

FIG. 6 is a process 600 for reward redemption according to some embodiments.

At 602, a consumer device displays reward offers for review. Multiple reward providers compete for consumer token redemptions. Reward providers are assumed to be analytics customers (or willing to purchase tokens from other reward providers) to use for purchasing analytics reports.

At 604, a consumer uses the consumer device to select a reward provider: The keypair-based identity application installed on the consumer device displays offers from the reward market, for example. The consumer selects a reward for which they have sufficient tokens to exchange.

At 606, a processor implements a reward selection transaction. When a reward is selected, the consumer issues a token transaction to claim the reward, supplying shipping information if required for physical rewards.

At 608, the processor triggers reward shipping. This can be the process of shipping the reward to the consumer, for example, or can include electronic transmission of the reward.

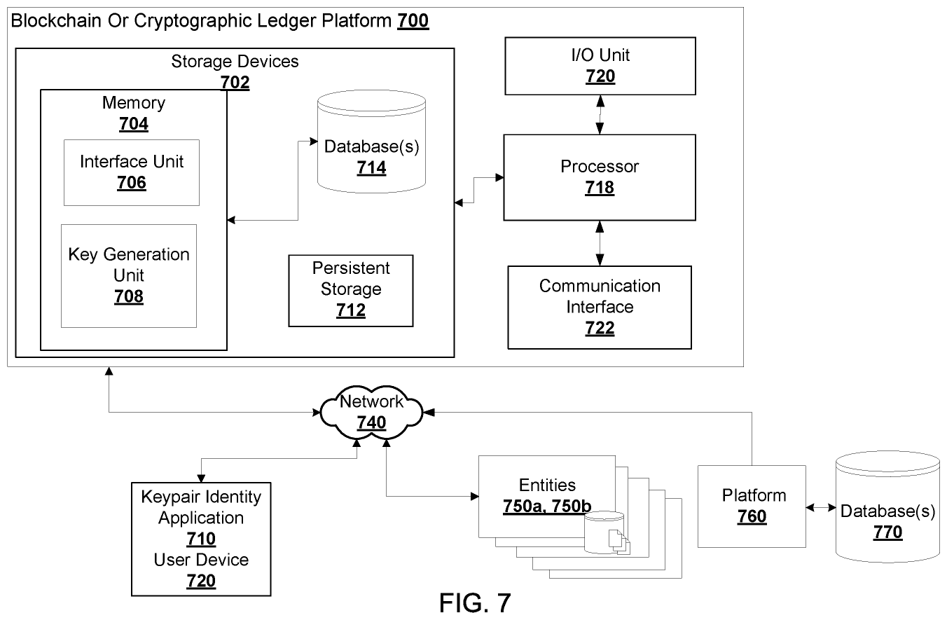

FIG. 7 is a schematic diagram of a blockchain or another cryptographic ledger management platform 700 according to some embodiments. The platform 700 can implement aspects of the processes described herein.

The platform 700 can connect to a keypair-based identity application 710 installed on user device 720 to be operated by a consumer. Entities 750a, 750b can interact or implement blockchain or other cryptographic ledger services to write blocks as records of a blockchain or distributed cryptographic ledger as described herein. In some embodiments, the platform 700 can connect to an analytics platform 760 coupled to one or more analytics databases 770. The analytics platform 760 may collect data on user behaviour (what they scan, when they scan it, advertiser ID of their device, etc.) and store such data into databases 770. In some embodiments, databases 770 comprise a cryptographic ledger to prove the validity of the collected data. In other embodiments, databases 770 may be implemented without any cryptographic ledger, and users of the collected data will have to trust its validity. Network 740 (or multiple networks) is capable of carrying data and can involve wired connections, wireless connections, or a combination thereof. Network 740 may involve different network communication technologies, standards and protocols, for example.

The platform 700 can include an I/O Unit 720, a processor 718, communication interface 722, and storage devices 702. The storage devices 702 can comprise memory 704 (including an interface unit 706 and a token unit 708), persistent storage 712 and databases 714.

The I/O unit 720 can enable the platform 700 to interconnect with one or more input devices, such as a keyboard, mouse, camera, touch screen and a microphone, and/or with one or more output devices such as a display screen and a speaker.

The processor 718 can execute instructions in memory 704 to implement aspects of processes described herein. The processor 718 can execute instructions in memory 704 to configure a data collection unit, interface unit 706, token unit 708, and other functions described herein. The processor 718 can be, for example, any type of general-purpose microprocessor or microcontroller, a digital signal processing (DSP) processor, an integrated circuit, a field programmable gate array (FPGA), a reconfigurable processor, or any combination thereof.

The interface unit 706 interacts with keypair-based identity application 710 to exchange data and generate visual elements for display at user device 720. The token unit 708 interacts with entities 750a, 750b and Management platform Platform 760 for package generation and reward redemption. Other functions are described herein.

Memory 704 may include a suitable combination of any type of computer memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Storage devices 702 can include memory 704, databases 714, and persistent storage 712.

The communication interface 722 can enable the platform 700 to communicate with other components, to exchange data with other components, to access and connect to network resources, to serve applications, and perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. WMAX), SS7 signaling network, fixed line, local area network, wide area network, and others, including any combination of these.

The platform 700 can be operable to register and authenticate users (using a login, unique identifier, and password for example) prior to providing access to applications, a local network, network resources, other networks and network security devices. The platform 700 may serve multiple users.

The storage 127 may be configured to store information associated with or created by the classification device 120. Storage 127 and/or persistent storage 128 may be provided using various types of storage technologies, such as solid-state drives, hard disk drives, flash memory, and may be stored in various formats, such as relational databases, non-relational databases, flat files, spreadsheets, extended markup files, etc.

The following provides example features of the platform 700 according to some embodiments. Properties of commodity are written to a database 714, the primary key of the database record is the transaction hash (protected) or written entirely to a blockchain or another cryptographic ledger transaction (fully transparent). Additionally, an Access-Control-List enabled blockchain or another cryptographic ledger can allow fine-grained access control to the properties data by platform 700.

When the commodity is packaged for wholesale shipment, the platform 700 writes the properties to a database record whose primary key can a salted cryptographic hash of the product's meta-data (such as, for example, strain location, biological data, branding information, growing conditions, particular handlers/trimmers). The hash is then written to the blockchain or another cryptographic ledger via entities 750a. The producer can choose to register the record with one or more “Reward Exchanges”, resulting in a competitive market for the producer data. The producer may also be obliged by regulation to register the record with government or other tracking systems, or choose to as part of a “Seed to Sale” regulated inventory management system. The competitive market of crypto-exchanges pays the producer in crypto-token to register their data. The market adds value by producing aggregations of producer data and forming analytics with traditional methods and machine learning.

The commodity is shipped to wholesale distribution and packaged for retail distribution. The transaction ID of the shipment properties is read by the platform 700. For each retail package, the platform 700 generates a token keypair (via token unit 708), with a private kay and a public key, where the public key is termed the keypair-based identity address. In one manifestation, the private key is generated by making a request to a Software-as-a-Service infrastructure providing the appropriate interfaces and cryptographically secure key generation services. The platform 700 generates the initial blockchain or another cryptographic ledger transaction that instantiates the keypair-based identity associated with the given consumer retail package.

The interface unit 706 can permit the registration of the package and instantiation of the logical representation of the product. The private key is hashed with a salt and used as the primary key to reference the meta-data record of the package, primarily the public key of the keypair-based identity and a copy of the hashed, salted private key to be used at a later date to look up the database record. The keypair private key is not stored by the backend service; it is securely destroyed once the API response is created and returned to the API caller. This provides a strong element of protection against insider threat at the central authority. After receiving the private key for the keypair-based identity generated for the package and other meta-data, such as the product properties or a reference to a blockchain or another cryptographic ledger transaction or database entry of a proprietary Seed-to-Sale tracking system, the packaging station generates a QR code or other machine-readable indicia that is fitted into the package such that it is not human or machine readable until the package seal is broken.

The package public and private keys are returned to the packaging station, as well as a copy of the salted hash of the private key used as the database primary key of the package record. The private key is used to generate a QR code or other machine-readable indicia that is written to media that is sealed within the package. This is the only un-hashed copy of the package private key. If the package is lost, destroyed or otherwise rendered unusable access to the keypair-based identity is lost forever. This is to ensure an element of user privacy is maintained should the consumer not wish to participate in the system. Because the keypair-based identity is not yet funded with a reward, no token is lost.

The package public key may be optionally written on the outside of the package so it can be read prior to sale. The package public key value can be sent to the SaaS service and used to return product information and branding data to the consumer application.

There are other viable implementation schemes, such as performing all cryptographic operations on the packaging station (requiring more stringent physical and logical security controls) for better de-centralization, or pre-generating keypair-based identity addresses in bulk in a backend service and having the packaging station store them. The key aspect, though, is that this system is only as strong as the process for generating and handling the keypair-based identity keys. Providing keypair-based identity generation of a secure Software-as-a-Service provides protection against a common class of security attack, though at a cost of a specific insider threat.

At this point, the product package keypair-based identity is empty (important for mitigating insider threat at the packaging manufacturer). At the wholesaler, the product is loaded into the packages that now have an embedded QR code or other machine-readable indicia and are shipped to the retailer for consumer distribution. As packages are utilized, the wholesale distributor assigns a very small, random amount of crypto-token to the package keypair-based identity. This acts as a flag that is sent to the SaaS API that signals that the package has product in it and is available for retail sale; however, the system will not allow redemption of the reward because the value in the wallet content is 0<current keypair-based identity value (flag value)<minimum redemption value. That keypair-based identity value is later used as a nonce to validate that the redeemed private key was activated by the correct wholesale producer and is most likely a legitimate retail sale.

When the retailer receives the product and registers it for inventory, it scans each public key on the outside of the package and sends it to the SaaS API. This registers and confirms that the packages are in the ownership of the particular retail branch and records this information. The SaaS can fund the package keypair-based identity at this time safely, or if there exists an integration with the Seed-to-Sale platform, the package keypair-based identity funding can be performed Just In Time when the retail purchase is actually made to minimize the opportunity for insider threat. Additional third-party promoters/advertisers can also add fractional tokens to further incentivize the user and provide more detailed purchasing behaviour tracking.

At the time of sale, in some embodiments the retailer is responsible for providing attestation that the purchaser is a legitimate consumer and compiles with the necessary regulation in their jurisdiction. The retail sale can be registered for compliance purposes either in a proprietary centralized database, or written to a blockchain or other cryptographic ledger platform that may or may not be related to the blockchain or cryptographic ledger described in this disclosure. In some embodiments, the cryptographic ledger token platform described herein may be fully decoupled from the Seed-to-Sale software utilized by the retailer. In other embodiments the cryptographic ledger token platform described herein may integrated with the Seed-to-Sale software via a plugin or other means.

Once the consumer lawfully obtains the package, the seal is breached and the QR code is machine read-able. To register in the platform 700, the consumer can download and install a keypair-based identity management application 710, and to create a secure personal keypair-based identity for their reward tokens. The consumer uses the application 710 to scan the QR code or other machine-readable indicia, giving them the private key of the package wallet and a copy of the salted hash value previously calculated when the package was registered and stored in the QR code or other machine-readable indicia data. The smart phone application then sends the hashed private key, signed using the keypair-based identity private key to prove physical ownership of the package to the SaaS infrastructure. The SaaS infrastructure uses the hashed key to look up the package's database record.

Contained within the database record is the ID of the blockchain or other cryptographic ledger transaction with the product meta-data that was stored when the producer shipped the wholesale product. Additional branding data can be stored in the proprietary database and returned to the user's smartphone app. This display of branding and product information is valuable to the consumer and will encourage them to “redeem” their package QR code or other machine-readable indicia for a token reward. This reward is a variable sum of crypto-token deposited to the package keypair-based identity to be dictated by the terms of the product marketer, and sold as a service by the platform 700.

To receive the reward, the consumer can consent to allow the platform to use and re-sell their data, in practical effect paying the consumer for their purchasing history data no different than other rewards programs (like Airmiles, etc.). On installation, the consumer software can generate a unique identifier in the form of a UUID code, that is submitted with every transaction to the SaaS API. This can provide a reasonably pseudo-anonymous tracking mechanism analogous to “cookies” utilized by websites for tracking browsing behaviour. The tracking scheme can be enhanced by the use of a common code shared among all user devices, but practically speaking this isn't necessary to achieve the market value of the collected data set. Providing a measure of privacy protection is a powerful system property. There might be no need to provide personal details, though similar privacy concerns such as those encountered by web-based advertising can be managed.

Once consent is given, currency is funded to the keypair-based identity. The consumer application 710 then automatically receives and transfers the currency from the package keypair-based identity to their own consumer keypair-based identity, giving them full control of the tokens even though the exchange never kept a copy of the private key. This provides an element of security against insider threat (with an obvious race condition during the token transaction that needs additional controls for mitigation) at the central authority, and can be designed in such a way to also provide a portion of the reward to the retailer that sold the product if there is a retail software integration to incentivize their participation (options will vary depending on jurisdiction requirements).

Finally, at this point the complete information record regarding the purchased product and a profile of the consumer is fully established. This data, by virtue of specific design choices, can be made to be anonymized. The platform will aggregate the data and sell the information to advertisers in exchange for crypto-token. Advertisers earn tokens by onboarding producers to their service. Producers earn tokens by agreeing to participate in the platform by committing to the shipment of a specific amount of product and paid out by the exchange. This completes the economic cycle.

The blockchain or other cryptographic ledger transaction ID may be encoded in the smart packaging by either the Package Manufacturer or the Retail Packager, and the commodity is sealed in the package for retail distribution. When the consumer breaks the packaging seal and accesses the protected QR code or other machine-readable indicia, there are multiple opportunities to ingest the data. First, the retailer may utilize a specific capability of the Seed-to-Sale System to record the consumer sale. They may sign a blockchain or other cryptographic ledger transaction of their own that includes the hash as an “advertiser ID” as an integration into other platforms. The most important ingestion for the purpose of this invention is the consumer smart phone app. The smartphone app retrieves from the smart packaging the transaction ID recording the meta-data associated with the product, possibly recorded by regulatory management or other enterprise resource planning software, but not necessarily. The transaction ID is then used to locate the blockchain or other cryptographic ledger transaction containing the product attributes record or the proprietary database key. If it is a database key, the keypair-based identity application 710 then queries the database to retrieve the product attributes record. As part of the same user operation, the consumer creates a new transaction to the blockchain that holds the ID of the commodity transaction as well as the consumer's ID (which may be a hash, as in Hyperledger ACL). This transaction completes the information cycle between the producer and the authenticated consumer.

The “Reward Exchange” has a balance of token. It uses its balance to “purchase” Consumer goods from Producers, or convert to fiat to buy goods. Different platforms may specialize in different kinds of rewards and compete for Consumer Tokens. When the Consumer redeems their tokens, the transaction ID of the commodity they purchased is stored in a detailed or anonymized user record. The Reward Exchange aggregates, analyzes and sells this information to Data Consumers such as Producers, Branding and Marketing, Advertising and others.

Additional secure databases can be integrated with this system. A bio-informatics database that contains a biological model of the Consumer could use purchasing information to automatically identify the consumed product and link its psycho-active properties to predict the effects on a given Consumer. Training models developed in controlled scientific experiments can be used to inform the users of how a product is likely to affect them in the public section of the record.

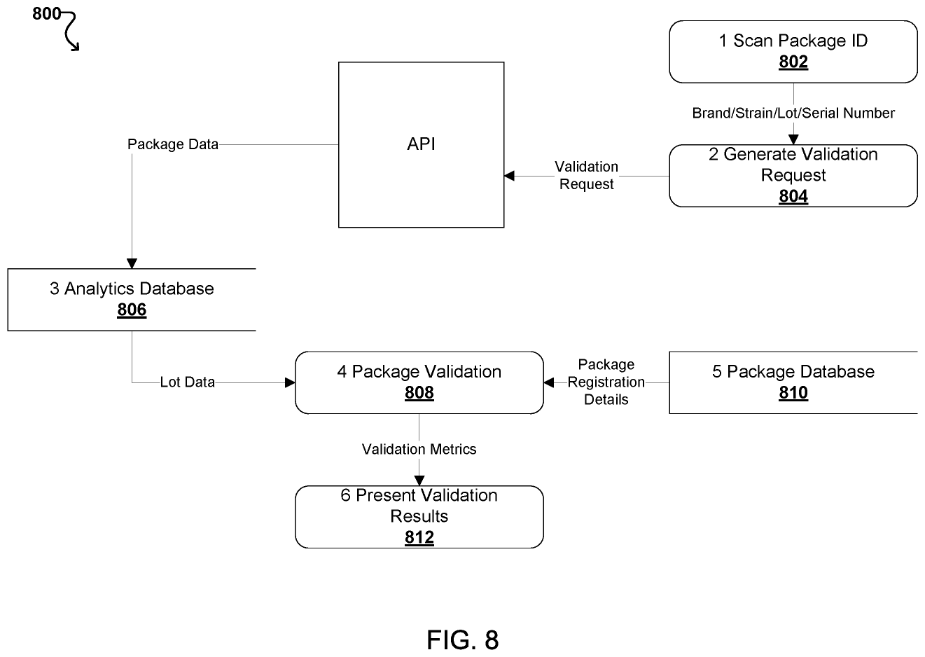

FIG. 8 is a flowchart diagram of a process 800 for verification according to some embodiments. There can be different processes for the verification of information used by the system and this is an example embodiment.

In some embodiments, the package can include a physical token with a QR code or other machine-readable indicia that can contain the package private key. The machine-readable code or indicia may be encoded on the package or on a physical item located within the package. The package private key might not be stored with management platform 100 for additional security in some embodiments. The package private key can be created when the producer registered the package, and then can be printed and inserted into the package for distribution to the consumer 106.

In some embodiments, the machine-readable indicia may be encoded using invisible ink and it may also contain tracking information on each package. The encoding may be done using a UV-only ink, so that a specialized sensor/UV-light source is required in order to read the printed QR code or other machine-readable indicia; without said equipment, the packaging looks plain to the naked eye. The machine-readable indicia can be multi-spectral, implying for example the QR code or other machine-readable indicia can be printed using ink visible only in near-UV.

There may be verification of the consumer or retail purchaser by a compliance inspector or an authorized agent of the appropriate regulatory jurisdiction, for example. At 802, there may be verification of the package initiated by scanning the machine-readable indicia or QR code using equipment (including a reader application installed as part of the keypair-based identity, or otherwise on a computing device), for example. The machine-readable indicia can indicate brand, lot, serial number, and other data, along with a package private key, for example.

Additional user verification (being either the retail product consumer or the compliance inspector) can be done: before the package is purchased (e.g. before the package seal is breached, providing access to the internal QR code or other machine-readable indicia to scan). This verification can retrieve product information based on the data available on the package (or encoded in a QR code or other machine-readable indicia on the front of the package). This can be scanned any number of times by any number of applications.

There can be verification of information about the product including the source of origin, contaminant testing, genetic testing, chemical composition, supply chain integrity and environmental production data is queried using information available on the outside of the package such as the brand, product name, lot number and serial number, which may be encoded as a QR code or other machine-readable indicia to simplify data entry but not necessarily, manual input also suffices. The consumer's application (presumably on a mobile device) adds additional information such as the application unique identifier and if permitted, the GPS coordinates at the time of query and historical information captured in the application.

At 804, the application can generate a validation request, which can include the encoded data retrieved by scanning the machine-readable indicia along with identification information of the request. The management platform 100 can receive the validation request by way of an API call, for example. The management platform 100 can generate package data in response to receiving the validation request. The package data can include the encoded data retrieved by scanning the machine-readable indicia along with identification information of the request.

Once the query is received by the management platform API 108, it records the application identifier and query data in the database to record that a given package was queried and it verifies the integrity of the information through correlation with lot registration and historical information previously captured during the registration process. Additional analytics are produced to indicate the probability that the given package is derived from a legitimate lot of product.

At 806, an analytics database receives the package data for storage and generates lot data. At 808, the lot data is used for package validation, along with package registration details received generated by a package database at 810. At 812, validation results are presented, by for example, updating an interface at a display device with validation result data. Once the query has been processed and verification is completed, the results can be returned to the consumer's keypair-based identity management application for viewing, for example.

Compliance inspectors can at any point in the supply chain use the same basic functionality but receive additional information generated from the analysis to provide indication when there is suspicion that a given package may not be legitimate, for example when a lot appears to have more retail packaged product volume that would be possible (e.g. the lot was 1 kg and 1200 g of packaged product has been detected through product information and/or reward redemption scans).

The foregoing discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

The embodiments of the devices, systems and methods described herein may be implemented in a combination of both hardware and software. These embodiments may be implemented on programmable computers, each computer including at least one processor, a data storage system (including volatile memory or non-volatile memory or other data storage elements or a combination thereof), and at least one communication interface.

Program code is applied to input data to perform the functions described herein and to generate output information. The output information is applied to one or more output devices. In some embodiments, the communication interface may be a network communication interface. In embodiments in which elements may be combined, the communication interface may be a software communication interface, such as those for inter-process communication. In still other embodiments, there may be a combination of communication interfaces implemented as hardware, software, and combination thereof.

Throughout the foregoing discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described herein are implemented by physical computer hardware, including computing devices, servers, receivers, transmitters, processors, memory, displays, and networks. The embodiments described herein provide useful physical machines and particularly configured computer hardware arrangements.

Although the embodiments have been described in detail, it should be understood that various changes, substitutions and alterations can be made herein.

Moreover, the scope of the present application is not intended to be limited to the particular embodiments of the process, machine, manufacture, composition of matter, means, methods and steps described in the specification.

As can be understood, the examples described above and illustrated are intended to be exemplary only.

What is claimed is:

1. A process for creating a keypair-based identity management application comprising:
generating a keypair-based identity;
calculating a keypair-based identity public address for the keypair-based identity using a keypair-based identity private key at a secure key storage;
transmitting the keypair-based identity public address to an application programming interface to generate a signed keypair-based identity address;
registering the keypair-based identity at a cryptographic ledger;
storing the signed keypair-based identity address at a producer storage; and
generating and depositing tokens to the signed keypair-based identity address using the cryptographic ledger.

2. The process of claim 1 further comprising transmitting attestation data along with the keypair-based identity public address to generate the signed keypair-based identity address.

3. The process of claim 1 wherein the keypair-based identity is a producer keypair-based identity generated for a producer of a product, and wherein generating and depositing tokens comprises generating and depositing tokens to a signed producer keypair-based identity address in response to the producer registering product information about the product.

4. The process of claim 3 further comprising generating a package keypair-based identity generated for a package of the product from the producer, and providing a package private key within the package.

5. The process of claim 4 further comprising generating a consumer keypair-based identity generated for a consumer purchasing the package, and generating and depositing tokens to a signed consumer keypair-based identity address in response to the consumer redeeming the package private key.

6. A system for tracking products, the system comprising:
a cryptographic ledger service configured to generate a plurality of keypair-based identity, each keypair-based identity comprising a keypair identity address, a public key and a private key;
a producer interface in communication with the cryptographic ledger service, the producer interface configured to:
receive a registration request and product information for a package of product from the producer; and,
provide the producer with a package keypair-based identity comprising a package public key for placement on an exterior of the package and a package private key for placement in an interior of the package such that the package private key is only accessible after opening the package; and, a consumer interface in communication with the cryptographic ledger service, the consumer interface configured to:
provide a consumer with a consumer keypair-based identity comprising a consumer keypair identity address, a consumer public key and a consumer private key;
receive a redemption request from the consumer, the redemption request comprising the package private key and the consumer public key;
validate the package and determine a package reward token for the package based on the package private key; and,
transfer the package reward token to the consumer keypair-based identity.

7. The system of claim 6 wherein the redemption request further comprises attestation data verifying that the consumer is a valid purchaser of the package.

8. The system of claim 6 further comprising an analytics platform configured to collect data based on user behaviour.

9. The system of claim 6 wherein the producer interface is configured to transfer a registration reward token to a producer keypair-based identity in response to receiving the registration request.

10. A process for tracking products and providing consumer rewards, the process comprising:
receiving a product registration request and product information for a package containing product from a producer;
providing the producer with a package keypair-based identity comprising a package public key for placement on an exterior of the package and a package private key for placement in an interior of the package such that the package private key is only accessible after opening the package;
providing a consumer with a consumer keypair-based identity comprising a consumer keypair identity address, a consumer public key and a consumer private key;
receiving a redemption request from the consumer, the redemption request comprising the package private key and the consumer public key;
validating the package and determining a package reward token for the package based on the package private key; and,
transferring the package reward token to the consumer keypair identity address.

11. The process of claim 10 comprising printing a machine-readable indicia containing the package public key on the exterior of the package.

12. The process of claim 11 wherein the machine-readable indicia is printed using ink visible only in ultraviolet (UV) or near-UV light.

13. The process of claim 10 comprising printing a machine-readable indicia containing the package private key on an interior surface of the package.

14. The process of claim 13 wherein the machine-readable indicia is printed using ink visible only in ultraviolet (UV) or near-UV light.

15. The process of claim 10 comprising printing a machine-readable indicia containing the package private key on an item for placement in the interior of the package.

16. The process of claim 10 comprising receiving attestation data from a retailer of the package confirming that the consumer is a valid purchaser of the package.
